(19) United States
(12) Patent Application Publication
(10) Pub. No.: US 2006/0222877 A1
(43) Pub. Date: Oct. 5, 2006

(54) Method of reducing the emission of aldehyde from wood based products

(75) Inventors: Farideh Khabbaz, Bromma (SE); Anders Eriksson, Nacka (SE)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL COATINGS INTERNATIONAL B.V., Arnhem (NL)

(21) Appl. No.: 11/393,984

(22) Filed: Mar. 30, 2006

Related U.S. Application Data
(60) Provisional application No. 60/667,127, filed on Apr. 1, 2005.

(51) Int. Cl. B32B 9/04

(52) U.S. Cl. 428/543

(57) ABSTRACT

The invention relates to a method of reducing emission of an aldehyde from a wood based product comprising applying at least one surface of a layer with one or more polymers containing a primary amine group. The invention further relates to a wood based product.

This application claims priority based on U.S. Provisional Patent Application No. 60/667,127, filed Apr. 1, 2005.

The present invention relates to a method of reducing the emission of an aldehyde, particular formaldehyde, from wood based products (especially layered products). It also relates to a wood based product, such as a flooring material, a furniture material, plywood, a wall panel and a roofing panel.

Formaldehyde based resins are widely used in binders and adhesive compositions, which are used in the manufacture of, e.g., fibre- and particle boards and glued products, which can be construction materials such as panels, decking, etc.; home furnishings such as furniture, flooring material, etc. Upon curing these binders and adhesive compositions, formaldehyde may be released during the manufacture of the product and also to a certain extent for a time period afterwards during use of the product. Formaldehyde present in indoor air is a major concern since many years for health reasons.

Moreover, especially a layered material, such as multi-layered parquet flooring, veneered flooring material or plywood can emit formaldehyde through one or more of the different wood layers which are commonly bonded together by gluing with a formaldehyde based adhesive. In the case of parquet flooring, the top layer usually consists of hardwood of a thickness of at least a few mm, the middle layer is usually softwood or a board, for example an MDF or particle board, and the backing layer is usually a veneer. In a veneered flooring material, the top layer is also a veneer, usually similar to the backing veneer. For both parquet and veneered flooring materials, the top layer is normally treated with a formaldehyde free UV-lacquer or an oil to protect the surface. This means that the emission of formaldehyde is not very significant through the top layer. The emission of formaldehyde from these types of products mainly constitutes emission through the backing layer. Also emissions from the sides (edges) contribute to some extent.

There is an increasing demand for flooring materials and other indoor building material which meet the more severe emission standards coming into force. In Japan, for example, there exists a classification of formaldehyde emission made according to any approved method, e.g. JAS MAFF for flooring or JIS A 1460, ranging from, so called, F* to F****, wherein F**** is now the most severe requiring formaldehyde emission of ≦0.3 mg/l (average).

Several attempts have been made for many years for reducing formaldehyde emission, but all entail significant mechanical, chemical, environmental or economical disadvantages.

WO 02/072323 A1 discloses a method of reducing the emission of formaldehyde from layered products wherein an inorganic sulphur containing salt. WO 02/072324 discloses a method of reducing the emission of formaldehyde from layered products wherein an ammonium salt is used. A preferred salt in both prior art disclosures is ammonium sulphite. U.S. Pat. No. 4,376,807 discloses post-treatment of wood panels with an ammonium salt. EP 0 812 948 A2 discloses a deodorant fibrous material. JP 2002-285125 A discloses an adhesive composition for producing plywood wherein a melamine resin is mixed with a formaldehyde trapping agent.

However, there is a need of further reducing the emissions in order to meet the increasing demand for materials having extremely low emission of formaldehyde. Furthermore, the use of solutions of salts according to prior art disclosures may lead to a layer of solid salt as crystals and/or powder on the surface treated. During handling this may lead to a fall-off of the salts from the surface thereby reducing the effect of the treatment. Also, a powdery surface is aesthetically non-attractive. Furthermore, the salt solutions used according to the prior art disclosures often give unpleasant smell during application which is negative to the working environment during the production of the products.

Thus, technical solutions are still wanted for how to further decrease the emission of formaldehyde from wood-based products containing formaldehyde-based resins, meeting the new more strict standards for formaldehyde emission. Also, when treating surfaces in order to reduce emission of formaldehyde, the problem with odour needs to be overcome as well as the problem of how to provide a mechanical resistant and aesthetically attractive treatment giving a long-lasting effect.

Accordingly, the present invention provides a method of an even further reduction of the emission of formaldehyde from wood-based products containing formaldehyde based resins compared to prior art methods. Also, a method of treating wood based products, especially layered products or layer(s) intended for layered products can be provided in which there is no significant bad odour as in prior art methods. The present invention also provides a possibility for a user-friendly production of wood based products by treatment with non-hazardous materials. The present invention also provides wood based products, especially glued products, which can be handled for a long time and without special care without reducing the emission-reducing effect of their treatment. Also, wood based products, especially glued products, which are more aesthetically attractive, can be provided.

The term “adhesive” herein used also includes binders for joining fibres, chips, particles or similar materials in order to form a wooden material such as a fibre board, particle board or chip board.

By “front layer” is herein meant a layer intended for, or already present in, a layered product, where at least two layers are glued together, and whose outer surface, “front surface”, when present in the glued product is intended to be visible when in use.

By “backing layer” is herein meant a layer intended for, or already present in, a layered product, where at least two layers are glued together, and whose outer surface, “backing surface”, when present in the glued product is not intended to be visible when in use.

The method, according to the invention, comprises reducing emission of an aldehyde from a wood based product comprising one or more layers, the wood based product comprises an adhesive emitting an aldehyde, wherein at least one surface of a layer is applied with or more polymers (P) containing a primary amine group. The wood based product is suitably a layered product comprising two or more layers. Suitably, the outer surface of an outer layer is applied with the one or more polymers (P). The layered product suitably comprises a front layer and a backing layer. The outer surface of the backing layer is suitably applied with the one or more polymers (P). In one embodiment, the outer surface of an outer layer, preferably the backing layer, is suitably applied with the one or more polymers (P), the outer layer already being glued to another layer. In another embodiment, the intended outer surface of an outer layer, preferably the backing layer, is suitably applied with the one or more polymers (P) before gluing the outer layer with another layer.

The one or more polymers (P) are preferably applied in the form of a solution (S).

The one or more polymers (P) have suitably a weight average molecular weight of from about 1.000 to about 1.000.000 g/mol, preferably from about 10.000 to about 800.000 g/mol, more preferably from about 20.000 to about 600.000 g/mol, even more preferably from about 50.000 to about 500.000 g/mol, most preferably from about 150.000 to about 400.000 g/mol. The amount of the one or more polymers (P) in the solution (S) is suitably from about 1 to about 90 weight %, preferably from about 3 to about 50 weight %, more preferably from about 5 to about 30 weight %, most preferably from about 7 to about 20 weight %.

The one or more polymers (P) are suitably applied in an amount of from about 0.1 to about 20 g/m², preferably from about 0.5 to about 10 g/m², most preferably from about 2 to about 5 g/m².

The solution (S) is suitably applied in an amount of from about 0.1 to about 100 g/m², preferably from about 1 to about 50 g/m², most preferably from about 5 to about 35 g/m². The suitable upper limit depends on which type of wood that is applied with the solution.

Preferably, the layer applied with the solution (S) according to the invention constitutes the outer surface of a backing layer of the layered product. This gives rise to a significant reduction of the emission of formaldehyde from the backside of the layered product.

Furthermore, also both of the surfaces of the outer layers may be applied with the same solution (S), or two different solutions (S) within the present invention, if so desired.

The solution (S) is preferably an aqueous solution, although other solvents than water may be used. The solution (S) may be applied by using any conventional coating technique, such as roller coating, curtain coating, or, spray coating.

Suitably, at least two layers have been glued together with an adhesive emitting an aldehyde. For a layered product comprising more than one glue joint, e.g. such as plywood, different adhesive types for different glue joints may be used.

The invention further relates to a wood based product comprising one or more layers, the wood based product comprises an adhesive emitting an aldehyde, wherein at least one surface of a layer comprises one or more polymers (P) containing a primary amine group. A surface of the wood based product suitably comprises from about 0.1 to about 20 g/m² of the one or more applied polymers (P), calculated as dry polymer, preferably from about 0.5 to about 10 g/m², most preferably from about 2 to about 5 g/m². The wood based product is suitably a layered product comprising two or more layers. The surface with applied one or more polymers (P) is suitably an outer surface of the layered product. The layered product suitably comprises a front layer and a backing layer, wherein the layers have been glued together with an adhesive emitting an aldehyde, and wherein the surface with applied one or more polymers (P) is an outer surface of the backing layer.

One or more of the layers in the wood based product may be made of a material which in itself comprises an adhesive emitting an aldehyde, the wood based product being, e.g., a fibre board or particle board. In such a case, the “layer” constitutes the fibre board or particle board itself. When the wood based product comprises one layer only, the material of the layer suitably in itself comprises an adhesive emitting an aldehyde, the wood based product being, e.g., a fibre board or particle board. In such a case, the “layer” constitutes the fibre board or particle board itself.

The one or more polymers (P) suitably belong to the group of polyvinyl amine, poly(vinylalcohol-co-vinyl amine), polyaminoamide, polyallylamine and polyethylene imine. More preferably the one or more polymers (P) belong to the group of polyvinyl amine and polyethylene imine. Most preferably polymer (P) is polyvinyl amine.

Polyvinyl amine is usually made by hydrolysing polyvinyl formamide to a certain degree. By “polyvinyl amine” is herein meant a polyvinyl amine wherein the mole ratio of amine groups to formamide groups is from 5:95 to 100:0. If the mole ratio of amine groups to formamide groups is less than 5:95 the polymer is defined as a polyvinyl formamide. The mole ratio of amine groups to formamide groups in the polyvinyl amine is preferably from about 10:90 to about 100:0, more preferably from about 50:50 to about 100:0, most preferably from about 80:20 to about 100:0.

Poly(vinyl alcohol-co-vinyl amine) is usually made by co-polymerising vinyl acetate and vinyl formamide followed by hydrolysis which gives a co-polymer having vinyl alcohol and vinyl amine units. There may also be remaining formamide groups in the co-polymer and also remaining acetate groups. The mole ratio of amine groups to formamide groups in the poly(vinyl alcohol-co-vinyl amine) is from 5:95 to 100:0. If the number ratio of amine groups to formamide groups is less than 5:95 the polymer is defined as a poly(vinyl alcohol-co-vinyl formamide). The mole ratio of hydroxyl groups to acetate groups in the poly(vinyl alcohol-co-vinyl amine) or poly(vinyl alcohol-co-vinyl amide) is suitably from about 25:75 to 100:0, preferably from about 75:25 to 100:0

Suitably, no substantial amount of additional inorganic or organic formaldehyde scavengers is applied to a surface in combination with the one or more polymers (P).

The adhesive emitting an aldehyde is suitably a formaldehyde based resin such as urea-formaldehyde-, melamine-urea-formaldehyde-, melamine-formaldehyde-, phenol-formaldehyde-, or phenol-resorcinol-formaldehyde-resin. Preferably, the adhesive emitting an aldehyde belongs to the group of urea-formaldehyde-, melamine-urea-formaldehyde-, and melamine-formaldehyde-resins.

In one embodiment of the invention at least one of the layers, according to the invention, is made up of a material which in itself comprises an adhesive emitting an aldehyde, such as a fibre board or particle board.

The backing layer suitably comprises a veneer.

The aldehyde is suitably formaldehyde.

In a preferred embodiment of the invention an aqueous solution of a polyvinyl amine having a polyvinyl amine content of from about 7 to about 20 weight %, the polyvinyl amine having a weight average molecular weight of from about 20.000 to about 600.000 g/mol, is applied to a backing veneer of a veneered flooring material, or parquet flooring, in an amount of from about 0.5 to about 10 g/m². The backing veneer is thereafter glued onto a core layer, or assembly of layers, with an adhesive based on a formaldehyde based resin such as a urea-formaldehyde resin.

The wood based product, according to the invention is suitably a flooring material, furniture material, plywood, a wall panel or a roofing panel. Preferably, it is a parquet flooring or veneered flooring material.

The present invention also relates to a wood based product obtained by the method according to the invention. The wood based product is suitably a flooring material, furniture material, plywood, wall panel or roofing panel.

The invention is further illustrated by means of the following non-limiting examples. Parts and percentages relate to parts by weight respectively percent by weight, unless otherwise stated.

### EXAMPLES

### Example 1

Different amide- or primary amine-containing polymers were tested for their effect as formaldehyde scavengers. An adhesive comprising UF resin and hardener was applied to a thickness of 0.1 mm onto a piece of glass. The adhesive was dried and polymer was applied by a small brush onto the adhesive. The test piece was put in a closed beaker for 60 minutes at 40° C. above 25 ml water which was used for absorbing emitted formaldehyde. The emission of formaldehyde was measured by analysing the formaldehyde content in the water. A reference was run parallel to each test with no polymer applied and its emission value is within brackets.

TABLE 1

| | Formaldehyde emission |
|---|---|
| Polymer | mg/g [adhesive] |
| polyvinyl amine¹ | 0.01 (2.95) |
| polyvinyl formamide | 1.59 (2.95) |
| polyethylene imine | 0.01 (2.76) |
| polyvinyl alcohol | 1.51 (3.00) |
| polyacryl amide (Mw 1.500) | 1.96 (2.76) |
| polyacryl amide (Mw 22.000) | 2.73 (2.76) |
| polyaminoamide | 0.21 (2.79) |
| poly(vinyl alcohol-co-vinyl amine) | 0.54 (3.19) |

¹mole ratio amine to amide groups 95:5

### Example 2

A veneered flooring material was made having a core of HDF board with 0.6 mm oak veneer glued on both sides with a UF adhesive. The upper surface intended to be visible of the flooring material was lacquered with a UV lacquer, thereby forming a wear resistant layer which also acts as a barrier for emission. Before gluing, the surface of the backside layer was applied with 25 g/m² of an aqueous solution of 12 weight % polyvinyl amine. The number ratio of amine groups to formamide groups was more than 90:10. The weight average molecular weight of the polyvinyl amine was 340.000 g/mol. As reference, a non-treated layered product was made. The amount spread of the compositions was 25 g/m².

Pieces (15×15 mm) were cut out and the emission of formaldehyde was measured according to JIS A 1460 (2001).

TABLE 2

| | | Surface | |
|---|---|---|---|
| Pre- treatment | Formaldehyde | appearance | Smell at |
| of backing veneer | emission (mg/L) | after drying | application |
| no treatment | 1.2 | — | — |
| ammonium sulphite | 0.7 | powdery | odour |
| solution | | | |
| polyvinyl amine | 0.1 | transparent no | no smell |
| solution | | visible particles | |
| | | smooth | |

1. Method of reducing emission of an aldehyde from a wood based product comprising one or more layers, the wood based product comprises an adhesive emitting an aldehyde, wherein at least one surface of a layer is applied with one or more polymers (P) containing a primary amine group.

2. Method according to claim 1, wherein the wood based product is a layered product comprising two or more layers and wherein the outer surface of an outer layer is applied with the one or more polymers (P).

3. Method according to claim 1, wherein the wood based product comprises a front layer and a backing layer and wherein the outer surface of the backing layer is applied with the one or more polymers (P).

4. Method according to claim 3, wherein the outer surface of the backing layer is applied with the one or more polymers (P) before gluing it with another layer.

5. Method according to claim 3, wherein the outer surface of the backing layer is applied with the one or more polymers (P) after it has been glued to another layer.

6. Method according to claim 3, wherein the backing layer comprises a veneer.

7. Method according to claim 1, wherein the one or more polymers (P) are applied in an amount of from about 4 to about 10 g/m².

8. Method according to claim 1, wherein the one or more polymers (P) are applied in the form of a solution (S).

9. Method according to claim 1, wherein the one or more polymers (P) have a weight average molecular weight of from about 20.000 to about 600.000 g/mol.

10. Method according to claim 8, wherein the amount of one or more polymers (P) in the solution (S) is from about 5 to about 30 weight %,

11. Method according to claim 8, wherein the solution (S) is applied in an amount of from about 0.5 to about 10 g/m².

12. Method according to claim 1, wherein at least two layers are glued together with an adhesive emitting an aldehyde.

13. Method according to claim 1, wherein at least one of the one or more layers is made up of a material which in itself comprises an adhesive emitting an aldehyde.

14. Method according to claim 1, wherein the wood based product is a flooring material, furniture material, plywood, a wall panel or a roofing panel.

15. Method according to claim 1, wherein the one or more polymers (P) belong to the group of polyvinyl amine, poly(vinylalcohol-co-vinyl amine), polyaminoamide, polyallylamine and polyethylene imine.

16. Method according to claim 1, wherein the adhesive is based on a urea-formaldehyde-, melamine-urea-formaldehyde-, melamine-formaldehyde-, phenol-formaldehyde-, or phenol-resorcinol-formaldehyde-resin.

17. Wood based product comprising one or more layers, the wood based product comprises an adhesive emitting an aldehyde, wherein at least one surface of a layer comprises one or more polymers (P) containing a primary amine group.

18. Wood based product according to claim 17, wherein a surface of a layer comprises from about 0.5 to about 10 g/m² of the one or more applied polymers (P), calculated as dry polymer.

19. Wood based product according to claim 17, which is a layered product comprising two or more layers comprising a front layer and a backing layer, wherein the layers have been glued together with an adhesive emitting an aldehyde, and wherein the surface with applied one or more polymers (P) is an outer surface of the backing layer.

20. Wood based product according to claim 17, wherein at least one of the one or more layers is made up of a material which in itself comprises an adhesive emitting an aldehyde.

21. Wood based product according to claim 17, which is a flooring material, furniture material, plywood, a wall panel or a roofing panel.

22. Wood based product according to claim 17, wherein the one or more polymers (P) belong to the group of polyvinyl amine, poly(vinylalcohol-co-vinyl amine), polyaminoamide, polyallylamine and polyethylene imine.

23. Wood based product according to claim 17, wherein the adhesive is based on a urea-formaldehyde-, melamine-urea-formaldehyde-, melamine-formaldehyde-, phenol-formaldehyde-, or phenol-resorcinol-formaldehyde-resin.
